(19) United States
(12) Patent Application Publication
(10) Pub. No.: US 2015/0360507 A1
(43) Pub. Date: Dec. 17, 2015

(54) STRATIFIED AND AGGLOMERATED ARTIFICIAL STONE ARTICLE

(71) Applicant: COSENTINO RESEARCH AND DEVELOPMENT, S.L., Cantoria (Almeria) (ES)

(72) Inventors: Jose Manuel BENITO LOPEZ, Cantoria (Almeria) (ES); Leopoldo GONZALEZ HERNANDEZ, Cantoria (Almeria) (ES); Juan Antonio JARA GUERRERO, Cantoria (Almeria) (ES)

(73) Assignee: COSENTINO RESEARCH AND DEVELOPMENT, S.L., Cantoria (Almeria) (ES)

(21) Appl. No.: 14/759,263

(22) PCT Filed: Jan. 11, 2013
(86) PCT No.: PCT/ES2013/070006

§ 371 Date: Jul. 6, 2015

(51) Int. Cl. B44F 9/04; E04B 5/04; B29C 43/28; A47B 77/02

(52) U.S. Cl. CPC B44F 9/04; A47B 77/022; E04B 5/04; B29C 43/28; B29C 2043/561

(57) ABSTRACT

The present invention relates to those articles that include any kind of agglomerated artificial stone and polymerisable resin, such as tiles or slabs, to be used as construction material, characterised for consisting of different strati or veins, of heterogeneous variable mass that provide a special aesthetic effect similar to the natural stone products.

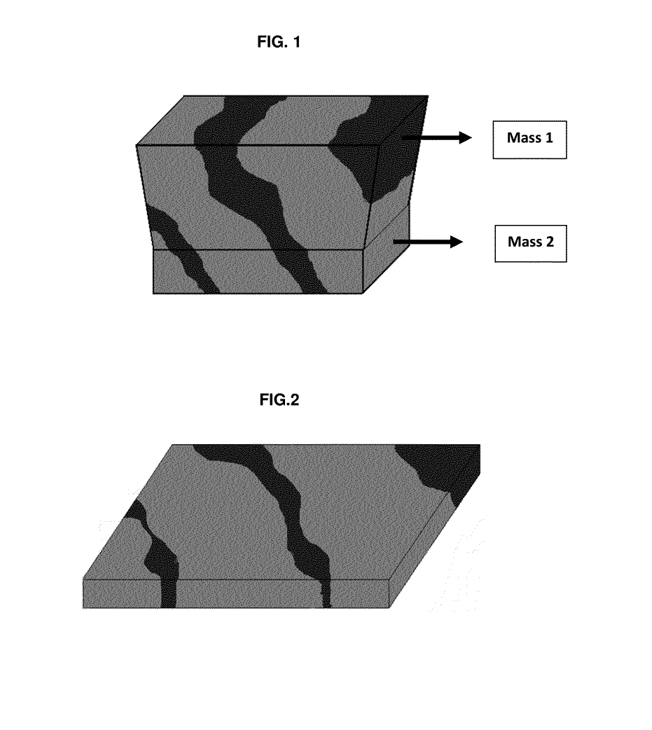

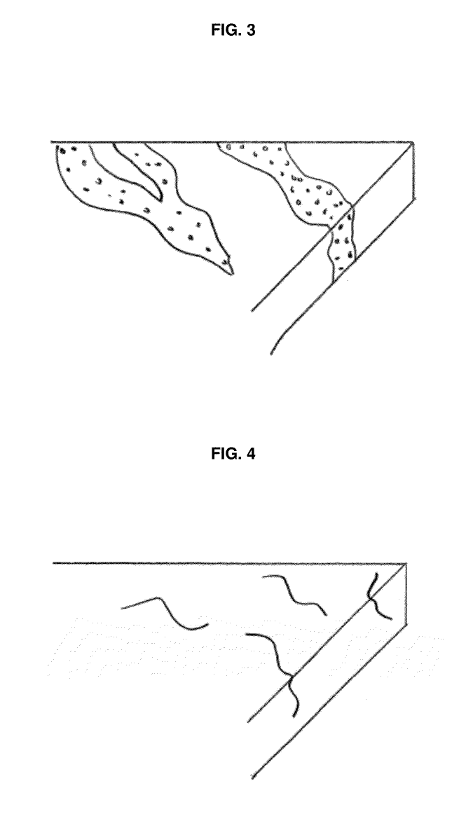

Stratified, agglomerated artificial stone articles with polymerisable resin and process for its manufacturing by vacuum vibro-compression system.

### TECHNICAL PART

The present invention relates to those articles that include any kind of agglomerated artificial stone and polymerisable resin, such as tiles or slabs, to be used as construction material, characterised for consisting of different strati or veins, of heterogeneous variable mass that provide a special aesthetic effect similar to the natural stone products that have a nature consisting in different layers or veins, depending on their lithological composition. A stratified product is achieved, where the layers (that can be considered as big size veins); they have a width and length of grater dimensions than the products existing in the state of the art, exceeding the technical limitation in this sense. This makes the naturalness of the resulting product to be higher. Also an object of the present invention is the process to manufacture tiles or slabs made of agglomerated artificial stone that include the controlled placing of the heterogeneous multi-mass strati in a manufacturing process of agglomerated artificial stone articles with the vacuum vibro-compression system. This controlled and not random placement of the layers is another factor that allows increasing the natural look of the products, making them different to the current, where the introduction of veins is uncontrolled and thus, it does not follow any ruled or controlled placement pattern.

The regular processes to manufacture artificial stone tiles or slabs include, in general, a crushing stage for the different materials with different granulometries to create the fillers; another stage that consists of the addition of the resin with the catalyser and, optionally, a colouring agent; the mix of such two previous stages until the homogenization of the materials with the resin; a later stage to model and compact the paste by a vacuum vibro-compression system; a hardening stage consisting in the polymerization reaction of the resin by heating; ending with a cooling, cutting and polishing stage.

Including at least two different mass mixing stages is the essential characteristic of the process described in the present invention. In each one of them, there are different petrous and artificial materials, in different proportions, compositions and granulometry, which mixed in their suitable stage that include the resin and other additives like, for example, a catalyser and, optionally, a colouring agent; they are distributed in a controlled manner and not randomly in the mould giving place, after the vacuum vibro-compression, hardening, cooling, cutting and polishing stage to a petrous agglomerated article such as a tile or slab made of artificial stone that has an heterogeneous multi-mass decorative effect which shows an aesthetic look similar to natural stone, with a greater layer effect than those vein effects achieved until now and described in the state of the art, thus surpassing the existing technical limitation.

### STATE OF THE ART

Currently, petrous agglomerated articles are used as decorative surfaces in interior and exterior spaces, such as kitchen worktops, bathrooms, flooring, exterior staircases, etc., being an important condition for these products as these also provide good technical characteristics in that related to resistance, a look as close as possible to natural stone which design can be defined by different layered minerals, with different granulometries and varied colours.

Different techniques are already known to manufacture artificial stone articles that show an aesthetic effect similar to that of natural stone.

For example, in the ceramic sector, the document WO2005068146, owned by Sacmi, provide a plant to make tiles or ceramic slabs that include a mean to feed a mixture of powders which have different characteristics and colours to a hopper that has the shape of a rectangular box; this hopper has a loading opening and an unloading opening defined between the front and the back sides. Through the unload opening, place a strip of powder present in the hopper over an underlying moving reception surface which moves forward; this strip has the same width and thickness of the hopper unloading opening; compress the powder strip characterised because compacting takes place over the reception surface. The object of this plant is to provide with a method to manufacture tiles or ceramic slabs especially, but not exclusively, in a continuous cycle press.

Amongst others, the process marketed by Breton S.p.A (Italy) that developed the technology named “Breton Stone” and that is described in the U.S. Pat. No. 4,698,010 (Marcello Toncelli, 6 Oct. 1987) where aggregates of a material with variable particles are mixed with a binder (organic or inorganic), and after such mixture has been made homogeneous, it gets to a mould which is also moved inside a press where it is submitted to pressure and vibration on vacuum conditions, hardening the mix which results in blocks that can be cut into others of different dimensions.

The product placed in the market by the authors of the present application as Silestone®, consisting in a natural quartz agglomerate and bound with polyester resin, which is based on the patent ES 2 187 313, describes the process to manufacture artificial stone slabs made of a mix of crushed materials of different granulometries of silica, granite, quartz, ferrosilicon and/or other materials such as plastics, marble and metals, with liquid polyester resins by vacuum vibro-compression, heating, cooling and polishing, especially applicable to the use in interiors and decoration.

The writing authors have also developed some slabs similar to these previously described in that related to the fillers but that use as polymer resin only a liquid methacrylate resin, PCT/ES2005/000152, so the slabs resulting are more resistant to ultra-violet light that can be used in walls, staircases and decoration of exteriors without risk of deterioration that can be caused by the continuous exposure to sun rays.

In the above mentioned cases, the different look of the slabs is achieved depending on the composition and the granulometry of the products included as fillers, giving colour to different proportions of fillers with various colours and afterwards, making homogeneous all the fillers until achieving a more or less uniform colour.

In other cases, the processes designed imply the creation of the said “veins” thus imitating the natural stone.

Amongst others, the process described in EP 0 970 790 is based in the use of a machine, object of the said patent, that first causes cavities in the surface of the mix that will build the slab, and later, such cavities are filled with the desired colorant.

Another method described in the patent application WO 03/027042 includes two alternatives depending if the binding product that builds the slab is of the “cement” kind or of the “polymer resin” using the powder pigment in the first case and the liquid pigment in the second. Once the base mix is made by a granulated material and a binding product, it is placed on a holder and it is sprayed on the surface with the liquid containing the pigment in a local and random manner so the patches or spots of a different colour appear without causing pigment agglomeration. Then, the mix is submitted to the compressing on vacuum vibro-compression stage and later to that of hardening, cooling, cutting and polishing. Another variation of the method consists in, that before or after adding the pigment solution, the surface of the mix is treated with an instrument like a rake that makes a wave movement so the colour mix is unevenly spread. The results of this treatment after having added the mix with the pigment is that the pigment patches or spots placed on the surface are distributed acquiring the desired vein effect.

In the application for international patent WO2009/010406 a process to manufacture tiles or slabs of artificial stone is described and it includes the basic stages of crushing of the different materials that made up the fillers with different granulometry, another stage that includes the resin and the catalyser and, optionally, the colour pigment, the mix of such stages until the homogenization of the materials with the resin, a stage of moulding and compressing of the mass got from the vacuum vibro-compression and a hardening stage by polymerization of the resin by heating, finishing with a cooling, cutting and polishing stage. The incorporation of veins that extend through the total thickness of the tile or slab, also acquires a tri-dimensional effect but its formation takes place by the incorporation of colouring agents to the surface of the paste in the mould, which are treated with a tool so they penetrate inside the paste and, like that, the vein acquires a tri-dimensional character.

In the U.S. Pat. No. 3,318,984 in favour of Christina Germain Louis Dussel, she makes reference to an artificial stone manufacturing process by the mix of thermosetting resins and mineral materials starting from the preparation of marble mixes or pastes of different colours sprayed together with a controlled mix of polyester resins. One of the pastes means the main portion of the artificial marble while the other or other pastes will be the spots or veins that will appear in the surface of the manufactured products. In such process the load of the different pastes is made loading by hand the different materials to the mould or by the use of a feeding mechanism with pre-defined settings, which will allow manufacturing elements with different colours in a single operation.

The application of the international patent WO2006/134179 presented by the holder of the present invention, describes a process for the manufacturing of artificial stone with polymerisable resin with a tri-dimensional vein effect by a vacuum vibro-compression system, achieving such vein effect by the addition of liquid or solid colouring mixed with the resin and added either at the mixing stage in upper mixers or in the inside of the homogenization ring either in the belt that carries the feeding mechanism or even inside it. The vein can be added in parts of the process where a later mix is made so the vein spreads throughout the entire tile.

However, with the methods mentioned in the state of the art simulations of the natural stone are achieved where the artificial character is still kept because the formation of veins is made by colouring always with pigmented resin that makes a greater difference between the veins and the rest of the product. Also, such veins have a width, length and situation in the product that makes that their similarity to natural stone is not completely satisfactory.

Especially, the great technical limitation is in the fact that, when creating the vein by liquid stages or solid pigments, the width that can be achieved of this is always very small (maximum 10 mm), so the stratified effects of certain natural stones cannot be achieved.

Also, a sufficient length of the veins cannot be achieved and the maximum length achieved in the state of the art is of circa 100 mm. In addition, in all the cases, these veins are placed in a randomly position in the mix, and sometimes areas of great concentration can be found and others, on the contrary, almost without veins.

All these technical limitations are translated, in most of the cases, in obtaining a product that keeps a certain artificial degree, being far from what natural stones are.

The technical limitation related to a predetermined width and length is mainly due to the loss of mechanical properties of the material in the vein area, due to the use in the composition of the vein of a larger amount of resin which necessary involves that the technical details of the product in these areas, such as hardness, resistance to UV light, shine, etc. are below the rest.

So, a manufacturing process for stratified artificial stone articles by vacuum vibro-compression technology that includes to the regular process the creation of, at least, two pastes or heterogeneous pastes of petrous agglomerated material of different granulometry is the object of the present invention. These pastes are placed in a controlled manner over the compacting mould and, after the compacting stage by vacuum vibro-compression, hardening and finishing, they will become the artificial stone article of the present invention that have in its total structure the same technical properties.

By this system of application of layers by the creation of different mixes the dimensions of the current veins, reaching a stratum width from 10 mm to 3400 mm preferably 500 mm and lengths that could cross the product in length and width, being the limit of length the dimension of the tile, as it can be 3400 mm, preferably 1700 mm. These strati (or large size veins), together with the location control of the said, make that the naturalness of the product is elevated, being difficult to know if it is an artificial or natural product.

Also object of the present invention are the articles, such as artificial stone tiles or slabs that have veins made by strati of different masses, these being made by fillers of variable granulometry and the corresponding polymerisable resin and also additives, characterised because the veins present a width from 10 to 3400 mm, preferably, 500 mm, and length from 100 to 3400 mm, preferably 1700 mm, being these artificial stone articles to be achieved by the process of the present invention.

The artificial stone articles of the present invention are apt for interiors and exterior decoration in walls, floors, staircases, etc. with a similar design to that of natural stone, created by tri-dimensional stratus of agglomerated paste or mass of artificial stone with controlled composition, thickness and weight which manage to overcome the disadvantages of the veining products such as the small dimension of the width and length of the vein, the conservation still of a certain character due to the use of one with a high content of resin and to the fact of not being able to achieve the stratified effects in a controlled manner.

### EXPLANATION OF THE INVENTION

The present invention is a process to manufacture artificial stone products, amongst others, tiles or slabs that include the following stages:
a) Crushing stage of the different materials with varied granulometry making up the fillers;
b) Obtaining by the addition and mix of the stage that contains the resin with the catalyser, the accelerant, the binding material and, optionally the colouring agent;
c) Mix of the products of the stages a) and b) until the homogenization and achievement of at least two pastes or masses of different granulometry. This process shall be independently made as many times as number of masses or pastes to be achieved. Each mass or paste, hereinafter called stratus, can be differentiated from the other thanks to its composition (granulometry, pigmentation, etc.)
d) Transportation of the different strati by a conveyor belt to the feeding or distribution mechanism. This download implies the ordered placing of the different strati in an independent manner and depending on the final design that is to be achieved. For this, the different strati are downloaded in the feeding or distribution mechanism, one after the other and in a certain amount.
e) Download of the strati, placed in an ordered manner in the previous stage, from the distributor to the mould which creates the design and dimension of the slab.
f) Protecting the mass that makes up the slabs with Kraft-type paper, or an elastomer, similar to a rubber coating;
g) Moulding and compressing of the paste in each mould by vacuum vibro-compression;
h) Hardening by polymerization of the resin by heating;
i) Finish with a cooling, sizing, polishing and cutting stage.

The process designed in the present invention is different to the processes known in the state of the art in the actions carried out during the stages c), d) and e).

During stage c), at least two pastes or masses of different composition are achieved (different granulometry, pigmentation, etc.) which will become the different strati of the stratified artificial stone product. On the contrary, the processes known in the state of the art only include the creation of a single paste with a single composition to create the final product, due to the later processes of mixing and homogenization.

During stage d) the different strati, with different composition, are transported in a conveyor belt from the mixers to the feeding or distributing mechanism, where they are placed or deposited on the said, in a certain order, to create the final desired product. On the contrary, the processes known of the state of the art do not include the controlled, ordered and stratified placement of the veins that are part of the product in the distributor or feeding mechanism.

At last, stage e) makes reference to the controlled directed and non-directed download of the strati placed in an ordered manner and present in the feeding mechanism or distributor to the mould.

On the contrary, the processes of the state of the art do not include the download of the different strati already placed in an ordered manner in the feeding mechanism directly to the mould.

### DESCRIPTION OF THE DRAWINGS

Drawing 1 represents a cross-wise cut of the feeding mechanism with a certain distribution of the different strati according to the present invention.

Drawing 2 represents the effect achieved in the final product from the distribution of the strati of drawing 1.

Drawing 3 represents another design of the stratified article where there are different granulometries in the different strati.

Drawing 4 represents a slab with vein effect according to the state of the art.

### DETAILED DESCRIPTION AND PREFERRED PERFORMANCE METHOD OF THE INVENTION

The goal of the present invention is, then, the achievement of a stratified agglomerated product that is capable of overcoming the technical limitations in that related to the width and length of the veins in the products currently known in the state of the art and to its controlled disposition in the core of the product. When increasing the dimension of the veins, a stratified effect is achieved in the final product which has an even more natural look.

So, object of the present invention are the articles such as tiles and/or slabs made of artificial stone that have veins built by strati of different masses, these being created by fillers of different granulometry and the corresponding polymerisable resin and also additives, characterised because the veins present a width from 10 to 3400 mm, preferably, 500 mm, and length from 100 to 3400 mm, preferably, 1700 mm.

To the effects of the present invention, the use of natural and artificial materials of variable granulometry is considered which will be part of the fillers, amongst others: marble, dolomite, opaque quartz, clear quartz, silica, crystal, mirror, cristobalite, granite, albite, basalt, ferrosilicon, etc. It also considers the use of other filler materials such as: colour plastics, metals, woods, graphite, etc. The said materials are part of the different strati, preferably with the following composition and granulometry:
10% to 70% of micronized filler, with a granulometry between 0.0001 mm to 0.75 mm;
0% to 80% of crushed fillers, named “crushed 1”, with a granulometry between 0.76 mm and 1.20 mm; and optionally,
0% to 50% of crushed fillers, named “crushed 2” with a granulometry between 1.21 mm and 15 mm.

The proportions of the different fillers are calculated in % of weight over the total weight that includes the fillers and the resin in the stratus.

The percentage of each granulometry in each stratus depends of the design of the slab to be achieved, modifying such percentages depending on the final result to be achieved.

The resin that is part of the paste is preferably unsaturated polyester resin; even if it also considers the use of other polymerisable and thermosetting resins such as: methacrylate resin, epoxy, unsaturated polyester, vinyl, etc.

The resin is part of the total mix of each stratus in a percentage between a 6% and a 30% of weight, being the percentage selection preferably between 7 and 20%.

Other additives that are part of the fillers are the catalyser, the accelerant, the binding product and, optionally, the colouring agent.

So, the process of the present invention, designed to get the stratified artificial stone products consists of the following stages:
a) Crushing stage of the different materials with varied granulometry making up the fillers;
b) Obtaining by the addition and mix of the stage that contains the resin with the catalyser, the accelerant, the binding material and, optionally the colouring agent;
c) Mix of the products of the stages a) and b) until the homogenization and achievement of at least two pastes or masses of different granulometry. This process shall be independently made as many times as number of masses or pastes to be achieved. Each mass or paste, hereinafter called stratus, can be differentiated from the other thanks to its composition (granulometry, pigmentation, etc.)
d) Transportation of the different strati by a conveyor belt to the feeding or distribution mechanism. This download implies the ordered placing of the different strati in an independent manner and depending on the final design that is to be achieved. For this, the different strati are downloaded in the feeding or distribution mechanism, one after the other and in a certain amount
e) Download of the strati, placed in an ordered manner in the previous stage, from the distributor to the mould which creates the design and dimension of the slab.
f) Protecting the mass that makes up the slabs with Kraft-type paper, or an elastomer, similar to a rubber coating
g) Moulding and compressing of the paste in each mould by vacuum vibro-compression;
h) Hardening by polymerization of the resin by heating
i) Finish with a cooling, sizing, polishing and cutting stage

The process starts with the stage a) where the starting material is prepared being crushed until achieving the desired granulometry, mixing the different percentages of each granulometry and then downloading it in the planetary mixers.

The preparation of different compositions of fillers with variable granulometry, which will be, in the end, the different homogenised pastes that are part of the strati of the final product is considered. In general, and for the creation of the products included in the present invention, at least two different compositions of masses with fillers of variable granulometry have to be prepared, even if, pending on the final product to be achieved, the preparation of up to 20 different compositions of masses with fillers of different granulometry is considered.

These different fillers are distributed in different mixers with the possibility that each one of them receives the optional addition of a solid colouring agent or pigment.

If the colouring agent is liquid, it is added in the resin stage.

In the stage b) the preparation of the additivated resin is made with the catalyser and the accelerant. This catalyzer can be any that creates free radicals, known from the state of the art. The peroxides and peroxidicarbonates are those preferred. They can be presented in powder (for example, dilauryl perioxide or di-(4-ter-butil-ciclohexile) peroxi-di-carbonate or a mixture of both, or liquid (for example, tert-butyl perbenzoate or tert-butyl peroxi-2-ethyilhexanoate or a mixture of both).

The accelerant can be a cobalt composed derived from caprylic acid, for example, cobalt octoate at 6%, a binding product and optionally the colouring agent.

The proportion of this resin in the composition of each paste shall be established by the composition of each stratus, being the resin percentage between a 6% and a 30% in weight, being, preferably, the selection of a percentage of between 7 and 20%.

The stage c), means, as previously stated, obtaining different masses, pastes or strati which are independently prepared in each mixer and always avoiding a later homogenization existing in the regular processes.

During stage d) the different strati are transported in a conveyor belt from the mixers to the feeding or distributing mechanism, where they are placed or deposited, in a certain order, sequence or amount desired. If drawing 1 is checked, where two different strati have been prepared (mass 1 and mass 2), these have been downloaded on the feeding system following this frequency: mass 2, mass 1, mass 2, mass 1, mass 2 and mass 1.

Considering performing a controlled download of the strati in the feeding or distribution mechanism in an ordered manner with the volume and amounts desired, the device includes weighting means, such as, belts or hoppers which allow defining and controlling the amount of paste that will create a stratus in the final product.

Additionally, the device includes means that allow performing a download in movement of the different pastes in the feeding or distribution mechanism in a way that the speed and trajectory of the movement can be controlled to achieve a design of each stratus in the final product. As the paste download is continuous, and thanks to the fact that the movement of the feeding system can be controlled, the strati can be downloaded in a heterogeneous and controlled manner. This is, the closer the feeding system gets to the stratus downloading area, more paste is downloaded and, as it moves further away, the amount is reduced. This swinging movement of the feeding system will allow drawing a strati design like that shown in the example in Drawing 1 where a certain tilt has been included in the strati setting in the feeding system. The combination of the weighting and movement means allows controlling the strati dimensions, for example, width, length, shape, etc. in the final product.

Next, in stage e), the groups of strati made and present in the feeding mechanism are downloaded so they will be distributed along the pressed mould to achieve a stratified final product in all the dimensions of the slab, this is, visible strati both in the upper and lower surface, as in the laterals. The download over the mould can be made in two different ways:
1. By a belt over where the strati coming from the feeding system have been downloaded.
2. Directly placing the exit of the feeding system over the mould and downloading the stratus from the conveyor belt directly to the mould.

Once the strati are distributed in the mould stages f), g), h) and i) take place which are regular and known for the state of the art.

So, the mould with the strati is protected with a paper or rubber. Once the mixture is protected and placed in the mould, it is taken to a vacuum vibro-compression press, which is in charge of squeezing and compressing the material but first it has to pass by a vacuum and then the material is squeezed by vibro-compression, following the method designed and described by the Italian company Breton SPA., as described in the U.S. Pat. No. 4,698,010.

The pressed tile is driven to an oven that is at a temperature between 80° C. and 110° C. for the resin to polymerise. The time of stay of each slab in the oven is from 30 to 60 minutes.

Once outside the oven, the slab is cooled for about 24 hours at room temperature in order to, later, calibrate, polish and cut it.

As final results, there is a slab with a stratified effect existing in all of its dimensions where the strati (which can be considered as big size veins) have a width and length of greater dimensions than the products existing in the state of the art. Thus, the final design is going to depend both of the shape, colour and granulometry of the materials that create the pastes or strati, as of the design provided with the different systems described in the present invention, achieving a petrous agglomerate with a more natural look, with more movement, more depth and a controlled stratified effects in all the dimensions of the product.

### EXAMPLES

### Example 1

Crushing in mills of the starting material until achieving the desired granulometry to finally get the filler material with the following granulometry distribution:
Crushed filler 1 of granulometry between 0.76-1.2 mm
Crushed filler 2 of granulometry between 1.21-15 mm
Micronized filler of granulometry between 0.05-0.75 mm

Now the crushed filler 1 and micronized filler are added to a planetary mixer where they are mixed with the resin, the catalyser, the accelerant and the colouring agent, in the following proportions to build paste 1:

69% crushed filler 1, 20% micronized filler, 11% resin, (% calculated over the total weight of the fillers and resin mixture)

0.2% of accelerant in proportion to the resin amount

2% of binding material in proportion to the resin amount

2% of catalyser in proportion to the resin amount

4% of black colouring agent in proportion to the resin amount

Mixture starts until homogenization and obtaining the first paste which will be transported by a conveyor belt to the feeding mechanism.

Simultaneously, the crushed filler 1, crushed filler 2 and micronized filler are added in a planetary mixer where the catalyser, the accelerant, the binding and the colouring agent are mixed with the resin in the following proportions to achieve mass 2.

34% crushed filler 1, 40% crushed filler 2, 17% micronized filler, 9% resin, (% calculated over the total weight of the fillers and resin mixture)

0.2% of accelerant in proportion to the resin amount
2% of binding material in proportion to the resin amount
2% of catalyser in proportion to the resin amount
4% of white colouring agent in proportion to the resin amount

Mixture starts until homogenization and obtaining the second paste which will be transported by a conveyor belt to the feeding mechanism.

The download of the pastes or masses in the feeding or distributor mechanism is made in a controlled and ordered manner and with the following sequence:

First, 15 Kg mass 2; second, 10 Kg mass 1; third, 30 Kg mass 2; fourth, 15 Kg mass 1; fifth, 25 Kg mass 2 and finally, 5 Kg mass 1.

This is, in this case, a thin tile with a total mass of 100 kg will be created being the total distribution of the two different masses in the final tile this following: 70% of mass 2 and 30% of mass 1.

Then the controlled download of the strati takes place, according to the previous stage, from the feeding mechanism to the mould and then moulding, compressing, hardening, and finishing treatment to the product with the most used techniques in the state of art.

1-14. (canceled)

15. Artificial stone tile and/or slab consisting of an heterogeneous multi-mass strati, characterized in that each stratus is made of a mass which comprises a filler of different petrous and artificial materials, in different proportions, compositions and granulometry.

16. Artificial stone tile and/or slab according to claim 15, characterised in that the strati present a width of between 10 to 3400 mm and a length of 100 to 3400 mm.

17. Tiles or slabs made of artificial stone according to claim 15, characterised in that the strati present a width of 500 mm and a length of 1700 mm.

18. Artificial stone tile and/or slab according to claim 15, characterised in that the different petrous and artificial materials of the filler are materials selected from the group consisting of: marble, dolomite, opaque quartz, clear quartz, silica, crystal, mirror, cristobalite, granite, albite, basalt and ferrosilicon.

19. Artificial stone tile and/or slab according to claim 15, characterised in that the composition and granulometry of each one of the fillers in each stratus contains (by weight):
10% to 70% of micronized filler, with a granulometry between 0.1 μm to 0.75 mm;
0% to 80% of crushed filler, named “crushed 1”, with a granulometry between 0.76 mm and 1.20 mm; and optionally,
0% to 50% of crushed filler, named “crushed 2” with a granulometry between 1.21 mm and 15 mm.

20. Artificial stone tile and/or slab according to claim 15 consisting of an heterogeneous multi-mass strati, characterized in that each stratus is made of a mass which additionally comprises a polymerisable resin.

21. Artificial stone tile and/or slab according to claim 20, characterised in that the polymerisable resin is thermosetting and is selected from the group consisting of unsaturated polyester resin, methacrylate resin, epoxy resin, unsaturated polyester and vinyl resins.

22. Artificial stone tile and/or slab according to claim 21, characterised in that the resin is present in a percentage between 6% and 30% by weight.

23. Artificial stone tile and/or slab according to claim 22, characterised in that the resin is present in a percentage between 7% and 20% by weight.

24. Artificial stone tile and/or slab according to claim 15, characterised in that each stratus is made of a mass which additionally comprises additives selected from the group consisting of catalysers, accelerants, binding agents and colouring agents.

25. Process for manufacturing the artificial stone tile and/or slab according to claim 15, characterised in that it consists of the following steps:
a) Preparation of different compositions of fillers with variable granulometry by crushing the different materials with varied granulometry making up the fillers;
b) Obtaining the resin stage by the addition and mix of the resin with the catalyser, the accelerant, the binding material and, optionally the colouring agent;
c) Mix of each of the fillers of step a) and the resin stage of step b) in independent mixers until the homogenization and obtaining of pastes or masses with different composition of fillers with different granulometry.
d) Transportation of the different strati (pastes or masses) of step c) by a conveyor belt to the feeding or distribution mechanism.
e) Download of the strati placed in an ordered manner, in the previous step, from the distributor to the compressing mould that creates the design and dimension of the slab.
f) Protecting the mass that makes up the slabs with Kraft-type paper, or an elastomer, similar to a rubber coating
g) Moulding and pressing of the paste in each mould by vacuum vibro-compression;
h) Hardening by polymerization of the resin by heating;
i) Finish with a cooling, sizing, polishing and cutting step.

26. Process according to claim 25, characterised in that step c) is repeated independently up to a total of 20 times depending on the number of pastes or masses that are to be included in the final artificial stone tile and/or slab.

27. Process according to claim 25, characterised in that step d) implies the ordered and independent placing of the different strati in the conveyor belt and the ordered and independent download of the said in the feeding or distribution mechanism in the desired amounts.

28. Process according to claim 25, characterised in that step e) is carried out by means of a belt where the strati coming from the feeding systems have been downloaded or directly supporting the exit of the feeding system over the compressing mould and downloading the group of strati from the conveyor belt directly to the mould.
